(19) United States
(12) Patent Application Publication
(10) Pub. No.: US 2012/0127406 A1
(43) Pub. Date: May 24, 2012

(54) REFLECTIVE DISPLAY

(76) Inventors: Adrian Geisow, Portshead (GB); Stephen Kitson, Bristol (GB)

(21) Appl. No.: 13/386,774

(22) PCT Filed: Dec. 18, 2009
(86) PCT No.: PCT/US09/68662

§ 371 Date: Jan. 24, 2012

(51) Int. Cl. G02F 1/1335

(52) U.S. Cl. 349/113

(57) ABSTRACT

A reflective display includes a display cell having a light incident wall, a second wall, and a reflective layer. A cholesteric liquid crystal fluid is disposed within the display cell between the light incident wall and the reflective layer and a plurality of pigment particles are movably suspended within the cholesteric liquid crystal fluid.

### BACKGROUND

Reflective visual displays can be used in a variety of applications including computer monitors, personal digital assistants, cell phones, watches, and other devices. Reflective displays have a number of advantages over traditional backlit LCD devices, including low power consumption and excellent visibility in sunlight. Ideally, a reflective display would reflect back a high percentage of incident light within a given spectral band, regardless of the polarization. It may also be desirable for the pixels within the reflective display to exhibit fast switching times.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a cross-sectional diagram of an illustrative reflective display which uses reflection from a cholesteric liquid crystal fluid, according to one embodiment of principles described herein.

FIG. 2 is a cross-sectional diagram of an illustrative reflective display which uses reflection from a cholesteric liquid crystal fluid, according to one embodiment of principles described herein.

FIG. 3 is a cross-sectional diagram of an illustrative reflective display which uses reflection from a cholesteric liquid crystal fluid, according to one embodiment of principles described herein.

FIG. 4 is a cross-sectional diagram of an illustrative reflective display which uses reflection from a cholesteric liquid crystal fluid, according to one embodiment of principles described herein.

FIGS. 5A and 5B are top views of an illustrative reflective display, according to one embodiment of principles described herein.

FIG. 5C is a chart showing illustrative correlations between well area and total reflection of a reflective display, according to one embodiment of principles described herein.

FIG. 6 is a cross-sectional diagram of an illustrative reflective color display, according to one embodiment of principles described herein.

Throughout the drawings, identical reference numbers designate similar, but not necessarily identical, elements.

### DETAILED DESCRIPTION

Reflective displays have so far demonstrated only limited brightness, particularly if they are full color. According to one illustrative embodiment of the invention, the use of cholesteric liquid crystal fluids can improve the brightness of a reflective display. The cholesteric liquid crystal fluid can increase the effective aperture of a reflective cell and may also provide a switching threshold so that a passive matrix can be used to address the display. For example, a cholesteric liquid crystal fluid, which reflects one polarization of a specified spectral band of visible light, can be combined with an additional mirror layer to reflect the other polarization of that spectral band and a complementary pigment which absorbs the specified spectral band. The pigment can be collected into one or more small regions hidden from ambient light by the cholesteric fluid—this results in half the light that would hit this region and be absorbed being returned to the user by reflection from the cholesteric fluid—equivalent to halving the area of the collection area. This improves the brightness for the equivalent geometry, or makes the collection area easier to fabricate by allowing it to be larger for the same optical loss.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

There are a variety of techniques for creating reflective displays. However, these reflective displays have so far demonstrated only limited brightness, particularly if they are full color. Some electrophoretic reflective displays work by moving pigment particles through the depth of a display cell. When the pigments are near the top of the display cell, the color of the pigment is seen by an observer; when the pigments are near the bottom surface, the color of the fluid, or of a contra-moving pigment, is seen. Because these display cells have to hide one color with another, they can only show combinations of two colors. To create a full color display, a series of these display cells can be combined side by side. For example, red/black, green/black, and blue/black display cells can be combined side by side. In another embodiment, black/white switching display cells are arranged side by side with red, green, and blue color filters on top. These configurations severely restrict the brightness that can be obtained because only small portion of the display area is reflective for a given color. Additionally, these displays can have large absorption losses.

Other electrophoretic cells reversibly collect and spread the colored pigments, rather than just moving them from the top to bottom of the cell. The brightness is then limited by, amongst other things, the ratio of the collection area to the overall pixel area. To get good reflective color, absorptive pigments are spread through the area of the pixel in the absorbing state, and concentrated into a small area or region in the clear state. For example, to change the state of the pixel from an absorptive state to a clear state, the absorptive pigments could be collected onto an electrode surface within the pixel, which only covers part of the cell area. This concentrates the absorptive pigments into a small area of the pixel overlying the electrode surface.

In displays, cells which modulate red, green, and blue can be stacked together to give a full color display. There are typically other structures such as electrodes and/or thin film transistors in the display which also block the light, further reducing brightness. To enable a pixilated display, an active matrix is generally used. The active matrix can add complexity and further reduce the aperture of the pixel.

As discussed above, the incorporation of cholesteric liquid crystal fluids into display cells can both increase the brightness of a reflective display and reduce the complexity and cost of manufacturing the reflective display.

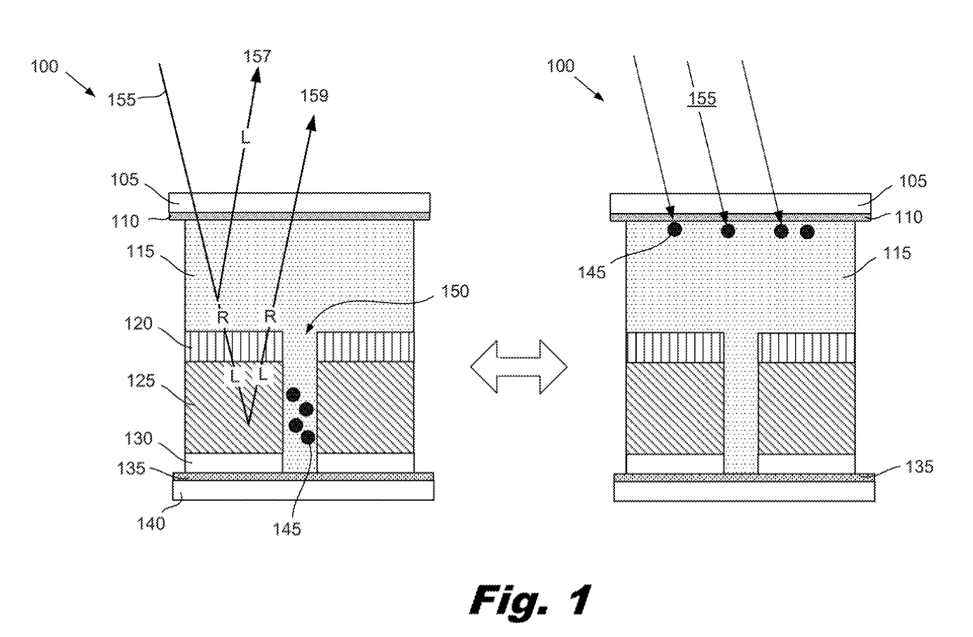

FIG. 1 is a cross-sectional diagram of an illustrative display cell (100) which incorporates a cholesteric liquid crystal fluid (115). An array of these display cells (100) can be used to form a reflective display. The display cell (100) is shown in a reflective state on the left portion of FIG. 1 and in an absorptive state on the right hand portion of FIG. 1. As described below, the display cell (100) can transition between the reflective state and the absorptive state.

According to one illustrative embodiment, the display cell (100) has a light incident wall (105) and a second wall (140). The display cell (100) is in its reflective state when pigment particles (145) are gathered toward the second wall (140) and in its absorptive state when the pigment particles (145) are gathered toward the light incident wall (105). An upper electrode (110) may be disposed in proximity to the light incident wall (105) of the display cell. The upper electrode (110) may be formed in a variety of ways, including the deposition of patterned Indium-Tin-Oxide (ITO), Zinc Oxide, or Zinc-Tin-Oxide (ZTO) on the substrate. In some embodiments, the light incident wall (105) and the upper electrode (110) may be substantially transparent over a range of optical wavelengths. Similarly, a lower electrode (135) may be disposed in proximity to the second wall (140). The upper and lower electrodes (110, 135) may be connected to thin film transistors which provide additional switching and matrixing capabilities.

As used the specification and appended claims, the term “second wall” refers to a wall within the display cell to which pigments are collected. The second wall of the display cell may be a bottom wall, sidewall, or other portion of the display cell.

A cholesteric liquid crystal fluid (115) provides a medium through which pigments (145) can move. In the reflective state, the pigments (145) are drawn into a well (150). According to one illustrative embodiment, the well (150) may be an aperture through one or more layers which are formed over the bottom electrode (135). For example, these layers may include a waveplate (120), a cholesteric polymer layer (125) and an optional spacer layer (130).

In some embodiments, the cholesteric liquid crystal fluid (115) is in contact with both the top and bottom electrodes (110, 135). There may be thin insulating layers (not shown for clarity), between the electrodes and the fluid, to prevent direct contact of the electrode material with the fluid. These thin insulating layers may also be used to provide suitable alignment to the cholesteric liquid crystal layer (115). According to one illustrative embodiment, the cholesteric liquid crystal fluid (115) may be configured to reflect light which has a particular polarization and wavelength or range of wavelengths. The reflective properties of the cholesteric liquid crystal fluid (115) are usually related to the helical pitch adopted by the fluid—one or more molecular elements of the fluid are chiral, and most of the elements are stiff, rod-like molecules. This results in the molecules being substantially aligned with their neighbors, but with an overall twist of this average direction through the bulk of the fluid. The cholesteric fluids or solids reflect either left handed or right handed circular polarized light. For example, if enough of the molecules which form the cholesteric liquid crystal fluid (115) have a left handed chiral structure, the fluid (115) may reflect left-hand circular polarized light while allowing the right-handed polarization of light to pass through the liquid crystal fluid (115).

In the illustrative example shown in the left portion of FIG. 1, a randomly polarized light ray (155) enters the display cell (100). In this example, the liquid crystal fluid (115) has a left hand chiral structure which reflects one polarization contained with the incident light ray (155). This divides the incident light ray (155) into two parts: the left-handed polarization of light (157) is reflected from the liquid crystal fluid (115) and the right-handed polarization of light passes through the liquid crystal fluid (115). In FIG. 1, left-hand polarized light is designated by an “L” overlying the light ray and right-hand polarized light is designated by an “R” overlying the light ray. Light rays with neither an “L” nor “R” designation are made up of a combination of left-hand and right-hand polarized light.

The liquid crystal fluid (115) acts as a reflector of one polarization component of incident light over the entire surface of cell. In this illustrative example, the liquid crystal fluid (115) reflects left-hand polarized light (157). This partially masks the presence of the absorptive pigments (145) in the well (150) by preventing the left-hand polarized light from reaching them. Consequently, instead of the left-hand polarized light being absorbed by the pigments (145) in the well (150), it is reflected out of the display. This maximizes the brightness of the display in its reflective state by reducing the absorption by the pigments. This can provide a display with increased brightness and/or allow for larger well sizes.

To maximize the brightness of the display, it is desirable that both polarizations are reflected. To accomplish this, the right-hand polarized light (159), which is not reflected by the cholesteric fluid, passes through a waveplate (120). As used in the specification and appended claims, the term “waveplate” refers to an optical retarder which alters the polarization of light traveling through it. A waveplate may be a zero-order waveplate or a multiple order waveplate. A typical waveplate may be a birefringent crystal or film with a specific thickness and orientation. According to one illustrative embodiment, the waveplate (120) may be a half waveplate which converts one polarization to the opposite polarization. In this example, the waveplate (120) converts light from a left-handed polarization to a right-handed polarization, and vise versa. Consequently, as the light ray exits the waveplate (120) and passes into the cholesteric polymer layer (125), it has the opposite polarization, as shown by the “L” superimposed on the light ray (159).

According to one illustrative embodiment, a cholesteric polymer layer (125) is used as an additional mirror to reflect the light which was not reflected by the cholesteric liquid. The cholesteric polymer layer (125) may be fabricated in a variety of ways, including coating cholesteric monomers onto a substrate and UV curing them to form a solid polymer layer. The cholesteric polymer layer (125) can be patterned in a variety of ways to produce the well (150), including masked exposure, patterned deposition, or imprinting.

In the embodiment shown in FIG. 1, the cholesteric polymer layer (125) also has a left handed chiral structure and reflects the light ray (159) which passed through the waveplate (120) back into the waveplate. As the light ray (159) passes through the waveplate for a second time, its polarization is reverted to its original right-hand polarized state. The light ray (159), with its original polarization restored, continues through the liquid crystal fluid (115) and exits from the display cell (100).

In the absorptive state illustrated on the right hand portion of FIG. 1, the pigments are distributed next to the upper electrode (110) by applying a voltage across the upper and lower electrode (110, 135). These pigments (145) absorb the incident light (155) within a given optical waveband and are transmissive in other optical wavebands. For clarity, only a few pigment particles (145) have been illustrated. Additionally, the scale of the pigment particles (145) has been altered. In practice, a larger number of particles could be present within the display cell.

By using cholesteric liquid crystals and a polymer reflector to reflect both polarizations of light, the overall brightness of a given color of the display is increased. As described above, the use of cholesteric liquid crystals improves the effective aperture of a reflective cell. The pigment is collected into one or more small regions hidden from one polarization of ambient light by the cholesteric fluid. Instead of incident light striking the collected pigments and being absorbed, the cholesteric fluid reflects one polarization of the incident light. This is equivalent to halving the area of the collection area. As used in the specification and appended claims, the term “collection area” refers to an area within which pigments are concentrated to reduce the absorption of light within the pixel. The use of a cholesteric fluid as a reflector improves the brightness for the equivalent geometry, or makes the collection area easier to fabricate by allowing it to be larger for the same optical loss.

Similarly, the cholesteric fluid may help reduce the loss due to switching transistors in an active matrix display. An active matrix typically uses individual transistors to direct a desired voltage to individual pixel electrodes. This can require layers and fabrication complexity to make and connect the transistors, pixel electrodes, and drive lines. They may also need to be screened from light, which can affect the performance of a transistor, by a light absorbing layer, sometimes known as a black matrix. According to one illustrative embodiment, the switching transistors may be present in a bottom layer of the display cell and control the electrical switching of the bottom electrode. In the reflective state, the cholesteric layer reflects half of the light before it reaches the switching transistors. Consequently, the undesirable absorption of light by the switching transistors, and any associated black matrix, can be reduced.

The cholesteric fluid may also provide a number additional of benefits when used in conjunction with a passive matrix. Passive matrix displays do not use transistors within the display cells. Instead, a passive matrix uses an array of stripe electrodes on a front surface and an array of intersecting stripe electrodes on a back surface. The pixels are disposed at intersections between a front stripe electrode and a back strip electrode.

Using the liquid crystal as the working fluid results in a threshold voltage for moving the electrophoretic pigment particles, and in bi-stability of the switched states. For example, a minimum voltage potential is applied to across the electrodes before the pigments move through the liquid crystal fluid. After the voltage is removed, the pigments tend to remain in place without further application of electrical power. The minimum threshold voltage required to move pigments within the cholesteric liquid crystal only occurs when both the front and back electrodes are energized. All that is required to access a given cell is to activate the intersecting electrodes. This can result in a display with significantly reduced complexity and manufacturing costs. This can result in a number of benefits, including significant power savings and the use of a passive matrix rather than active matrix.

In either active or passive displays, the use of cholesteric liquid crystal reflectors also improves the brightness by returning light before it traverses any display layers stacked beneath. As a consequence of reducing undesirable optical losses, color purity and gamut are also improved.

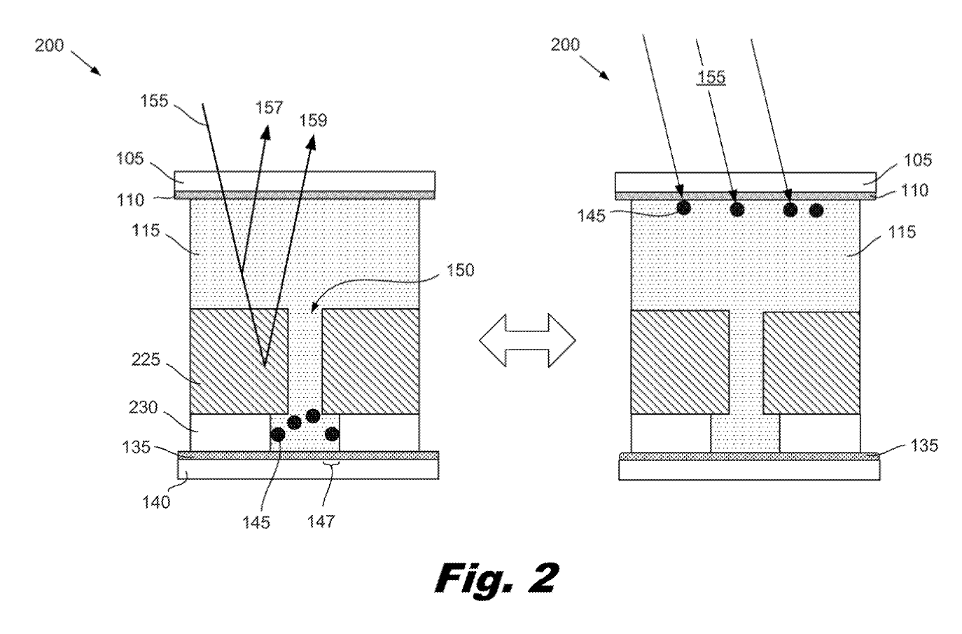

FIG. 2 is a cross-sectional diagram of reflective and absorptive states of an illustrative display cell (200). This display cell (200) is similar to the display cell of FIG. 1. However, this illustrative display cell (200) does not use a waveplate (120, FIG. 1) to change the polarization of light incident on the cholesteric polymer layer (225). Instead, cholesteric polymer layer (225) has a right handed chiral structure and reflects the polarization of light which passes through the left handed cholesteric liquid crystal fluid (115). One advantage of using a cured mesogenic layer (225) in contact with the liquid crystal layer is that the surface of the cured layer will align the liquid crystal above it.

A spacer layer (230) may also be included in the display. In some embodiments, the spacer layer (230) may include an undercut (147) so that some of the pigment can be hidden under the mirror above as shown in FIG. 2. This will further increase the reflective efficiency of the display cell (200).

In this illustrative embodiment, a light ray (155) which contains two polarization components passes through the light incident wall (105) and transparent electrode (110). The left handed cholesteric liquid crystal fluid (115) reflects a first polarization of light within the light ray (155). The remaining polarization (159) strikes the right handed cholesteric polymer layer (225) and is reflected out of the display.

As discussed above, the pigments (145) can be selectively drawn into the well (150) and undercut portion (147) of the spacer layer (230) to minimize their absorption of the incident light (155) in the reflective state. To change from a reflective to an absorptive state, the pigments (145) can be drawn out of the well and to the upper electrode (110) by applying a voltage across the upper and lower electrodes (110, 135). By positioning the pigments (145) close to the upper electrode (110), the incident light (155) is absorbed before it can be reflected by the liquid crystal fluid (115). For clarity, only a few pigment particles (145) have been illustrated. Additionally, the scale of the pigment particles (145) has been altered. In practice, a larger number of particles could be present within the display cell.

This illustrative display cell (200) also improves the effective aperture of its reflective cells. As used in the specification and appended claims the term “aperture” refers to the actual or equivalent area of a cell which exhibits dynamic optical effects which modulate reflected light. Similar to the embodiment shown in FIG. 1, the pigment collected in the well is partially shielded from ambient light by the cholesteric fluid. Consequently, half the light that would hit the pigment is the well is returned to the user by reflection from the cholesteric fluid.

Additionally or alternatively, the solid cholesteric layer (225) could be replaced by a wavelength selective mirror, such as a Bragg mirror or photonic crystal. Bragg mirrors are a structure which includes an alternating sequence of optical materials with different indexes of refraction. A frequently used design a quarter-wave Bragg mirror where each optical layer has a thickness which corresponds to one quarter of the wavelength for which the mirror is designed. The Bragg mirror will reflect both polarizations of the designed wavelength of light and is substantially transparent at other wavelengths. Photonic crystals are periodic optical nanostructures which affect the propagation of light. A wide range of photonic crystals could be used to reflect one optical wavelength or band of wavelengths while being transparent to other optical wavelengths.

In this and other embodiments, it may be desirable for the reflection of light by the display to be diffuse to produce a wide viewing angle. This may be accomplished in a variety of ways, including coating reflective elements over rough surfaces. In the cholesteric liquid crystal, it may be sufficient to use the domains that naturally tend to form. In some embodiments, the composition or structure of the cholesteric liquid crystal may be modified to improve the diffuse reflection from the cholesteric liquid crystal.

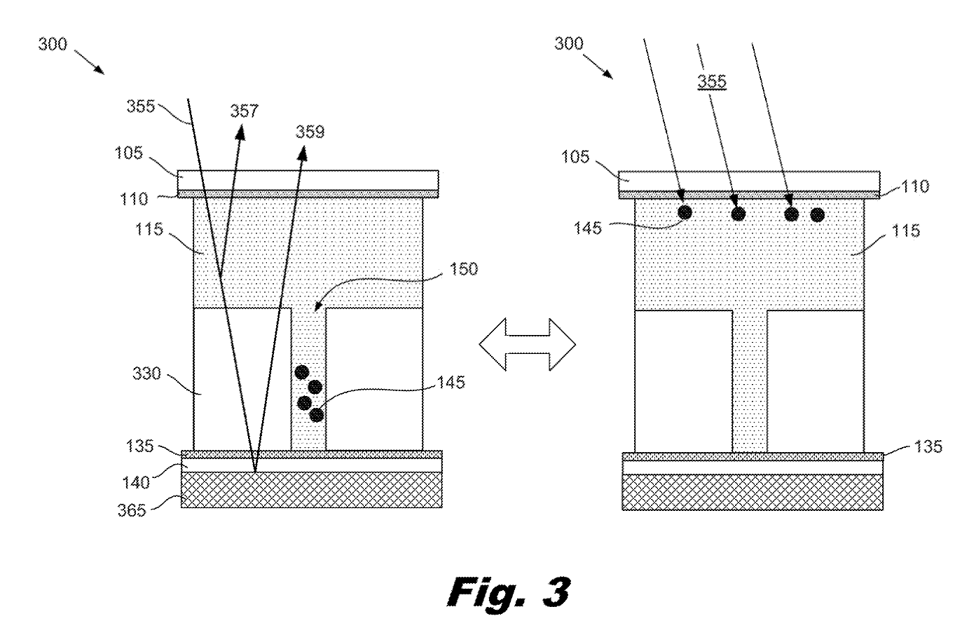

FIG. 3 is a cross-sectional diagram of one cell within an illustrative display cell (300) which uses a cholesteric fluid (115) to reflect one polarization of light (357) and uses a mirror (365) positioned beneath the cell to reflect the other polarization of light (359). According to one illustrative embodiment, the mirror (365) may be a reflective surface which selectively reflects a given waveband, while transmitting other wavebands. For example, the mirror (365) may be a Bragg mirror, a cholesteric reflector, a combination of a waveplate and cholesteric reflector, or photonic crystal.

As discussed above, the pigments (145) are collected in the well (150) in the reflective state of the display cell (300). In this illustrative embodiment, the well (150) is an aperture in a transparent spacer layer (330). The pigments (145) are drawn out of the well (150) to the upper electrode (110) in the absorptive state.

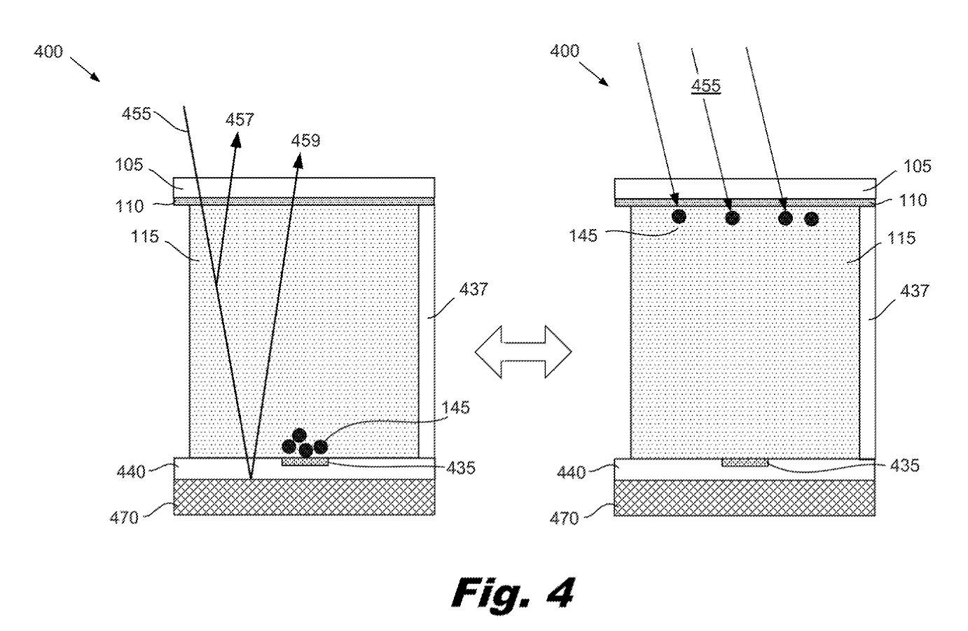

FIG. 4 is a cross-sectional diagram of an illustrative reflective cell (400). In this illustrative embodiment, internal structures which formed the well are absent. Instead, the area of the bottom electrode (435) has been reduced. According to one illustrative embodiment, the bottom electrode (435) has been patterned on the second wall (440). The bottom electrode (435) can be patterned in a variety of ways, including lithographic techniques, silk screening, gravure printing, micro contact printing, imprinting, or other suitable patterning techniques.

The smaller bottom electrode (435) draws the pigments (145) out of the volume of the cholesteric liquid crystal fluid (115) and into a relatively small area over the electrode (435). Consequently, in the reflective state, a first polarization of light (457) is reflected over the entire area of the cell (400). The second polarization of light is reflected by the underlying reflector (470) in portions of the cell (400) where the reflector (470) is not covered by the bottom electrode (435) and absorptive pigments (145).

The absorptive state illustrated on the right side of FIG. 4 operates in a similar manner as previously described embodiments. Incident light (455) of both polarizations is absorbed by pigments (145) which are proximate to the upper electrode (110).

The bottom electrode (435) could be formed in a variety of locations throughout the cell. For example, the bottom electrode (435) could be located anywhere on the bottom surface of the cell (400) or on a sidewall (437). As used in the specification and appended claims, the term “sidewall” refers to a surface of a display cell which is used to laterally confine the extent of the cell. The sidewall of a cell does not have to be substantially perpendicular to the plane of the display, but can have a variety of angles and structures which serve to laterally confine the extent of one or more cells within the display. In embodiments where an electrode is located on the sidewall, the sidewall may become the “second wall” of the display cell where pigments are collected.

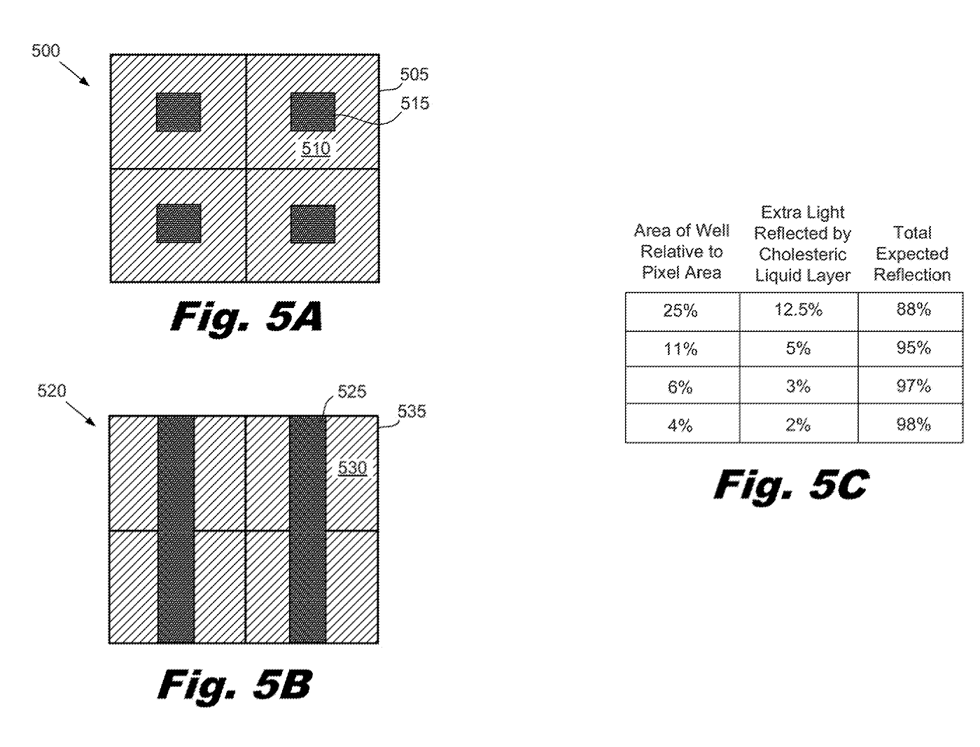

FIG. 5A is a top view of four cells (505) within a display cell (500). In this illustrative embodiment, a bottom rectangular electrode (515) covers a central portion of the overall area of each cell. As described above, the bottom electrode may be disposed within a well. The remainder of the cell area (510) is covered with a reflective surface. For example, the bottom electrode (515) may cover 11% of the total area of the cell. Without a cholesteric liquid crystal fluid, the maximum expected total reflection when the cell is in its reflective state would be 89%, which is the area of the cell which is unobstructed by the pigments clustered over the electrode. However, when a cholesteric liquid crystal fluid is used over the bottom electrode, the 11% loss of reflected light is reduced by half. As discussed above, the cholesteric liquid crystal selectively reflects one polarization of light. When the pigments are drawn to the bottom electrode (515), the cholesteric liquid crystal reflects one polarization of light over the entire area of the cell. The other polarization of light is absorbed by the pigments which are drawn to the bottom electrode, but reflected from the remaining surface area. Consequently, the maximum expected reflection for the cell which includes cholesteric liquid crystal is approximately 95%.

FIG. 5B is a diagram of four cells (535) in a reflective display (520). In this illustrative embodiment, the bottom electrodes (525) take the form of a strip which passes across each cell (535). According to one illustrative embodiment, the bottom electrode (525) may cover 25% of the total area of each cell (535). As discussed above, without the cholesteric liquid crystal fluid, the maximum expected reflection from this cell is approximately 75% which corresponds to the reflective area (530). When a cholesteric liquid crystal fluid is placed in the cell, the 25% light loss can be reduced by half. Consequently, the maximum reflected light would increase to 88% of the incident light.

FIG. 5C is a chart showing illustrative correlations between bottom electrode area/well area and total reflection of a display cell. As can be seen from the chart, the introduction of a cholesteric liquid layer decreases the light losses by half. For example, when the area of the well relative to the pixel area is 6%, the cholesteric liquid crystal layer reflects and additional 3% of the incident light. This results in a total expected reflection of about 97%.

The display as described above efficiently modulates the reflectivity within one spectral band. The incident light within that band is either reflected by the cholesteric liquid crystal fluid or by the additional mirror, or is absorbed by the pigments. For example, a display cell may be tuned to spatially modulate red wavelengths. When the red wavelengths are not a desired component in the reflected image, the cyan pigments are brought to the surface of the cell to absorb the red wavelengths. When the red wavelengths are desired in the reflected image, the pigments are pulled into the well and the majority of the red wavelengths are reflected by the cholesteric liquid crystal and the additional reflector.

A full color display can be realized by stacking 3 such displays, each designed to modulate a different spectral band—for example red, green and blue. As the reflectors in each layer return the relevant spectral band immediately, rather than passing the light through all the layers, the efficiency of the display is further enhanced over conventional stacked displays.

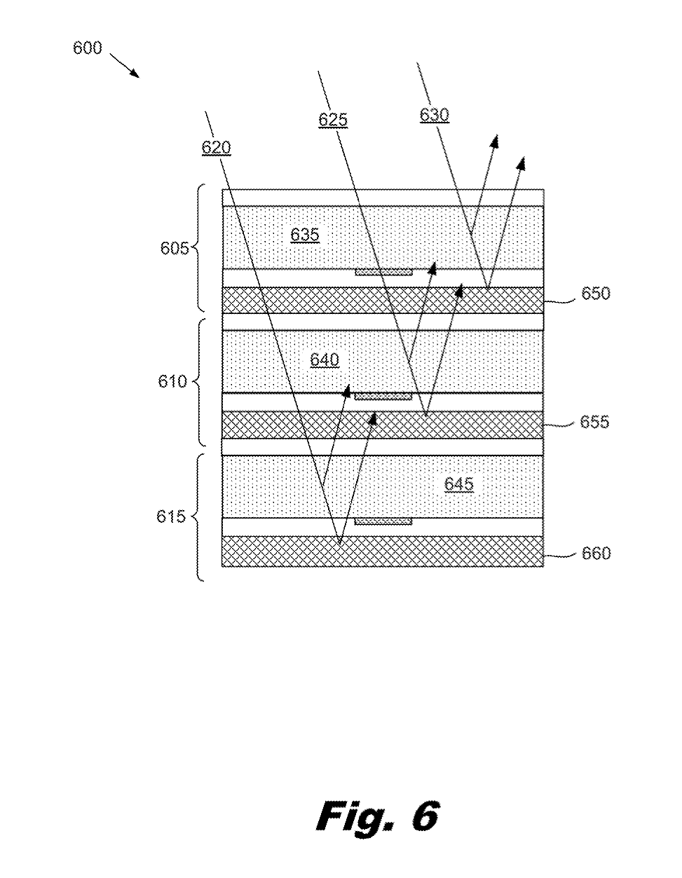

FIG. 6 is a cross-sectional diagram of an illustrative color display (600) which is made up of three stacked cells (605, 610, 615). These cell illustrations correspond the designs in FIG. 4, but could be any one of a number of designs, including those illustrated or described above. Each of the cells (605, 610, 615) is tuned to modulate a specific band of wavelengths. For example, the upper cell (605) may be tuned to modulate red wavelengths (630). The various components of the upper cell (605), including the cholesteric fluid (635), pigments, and reflective interlayer (650) may be tuned to the red wavelengths (630). The pigments in the upper cell (605) may be specifically selected to absorb red wavelengths (630) and the cholesteric fluid (635) and reflective interlayer (650) may be specifically tuned to reflect at least one polarization of the red light (630).

Similarly, the second cell (610) may be tuned to modulate a green spectral band (625), with the pigment being tuned to absorb the green spectral band (625) and the cholesteric liquid crystal (640) and reflective interlayer (655) being tuned to reflect the green spectral band (625). The third cell (615) may be tuned to modulate a blue spectral band (620), with the pigment being tuned to absorb the blue spectral band (620) and the cholesteric liquid crystal (645) and reflective interlayer (660) being tuned to reflect the blue spectral band (620).

The various cells (605, 610, 615) could have a variety of configurations and materials. For example, it would not matter if spectrally selective layers lower down in the stack (655, 660) have unwanted absorption or reflection bands as long as these overlap with layers higher up, as the light in those bands will be reflected or absorbed before reaching lower layers (655, 660).

In sum, improved brightness of a display cell can be obtained by using cholesteric liquid crystals as a selective reflector and as a fluid medium for the motion of absorptive pigments. The cholesteric liquid crystal fluid improves the effective aperture of a reflective cell by hiding collected pigments from one polarization of ambient light. This results in half the light which would have otherwise been lost to absorption by the absorptive pigments being reflected back to the user. This improves the brightness for the equivalent geometry, or makes the collection area easier to fabricate by allowing it to be larger for the same optical loss.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A reflective display comprises:
a display cell having a light incident wall and a second wall;
a reflective layer;
a cholesteric liquid crystal fluid disposed within the display cell between the light incident wall and reflective layer; and
a plurality of pigment particles movably suspended within the cholesteric liquid crystal fluid.

2. The display of claim 1, further comprising;
an upper electrode in proximity to the light incident wall of the display cell; and
a lower electrode in proximity to the second wall of the display;
in which a voltage applied across the upper electrode and the lower electrode moves the plurality of pigment particles within the cholesteric liquid crystal fluid.

3. The display of claim 1, in which the display cell exhibits a reflective state in which the plurality of pigment particles are collected in proximity to the second wall of the display cell, the cholesteric liquid crystal fluid being disposed between the pigment particles and incident light, the cholesteric liquid crystal fluid reflecting a first portion of incident light and the reflective layer reflecting a second portion of the incident light.

4. The display of claim 1, in which the display cell exhibits an absorptive state in which the plurality of pigment particles are drawn to the light incident wall and absorb a portion of the incident light.

5. The display of claim 1, in which the second wall is a side wall of the display cell.

6. The display of claim 1, the reflective layer is parallel to the second wall of the display cell.

7. The display of claim 6, in which the reflective layer is a solid cholesteric layer having a chirality which is opposite that of the cholesteric liquid crystal fluid.

8. The display of claim 6, further comprising a half wave plate interposed between cholesteric liquid crystal fluid and the reflective layer, the reflective layer being a solid cholesteric layer having a same chirality as the cholesteric liquid crystal fluid.

9. The display of claim 6, in which the reflective layer underlies the lower electrode.

10. The display of claim 2, in which the lower electrode is at the bottom of a well, the plurality of pigments being drawn into the well to produce the reflective state.

11. The display of claim 10, in which the well comprises an aperture within a clear polymer spacer.

12. The display of claim 10, in which the well comprises an undercut such that pigments are drawn into the well and undercut.

13. The display of claim 10, in which the well comprises an aperture within a solid cholesteric layer.

14. A color reflective display comprising:
at least two stacked display cells, each of the stacked display cells comprising:
a light incident wall and second wall;
a cholesteric liquid crystal fluid disposed within the display cell;
a pigment particles movably suspended within the cholesteric liquid crystal fluid; an
a reflective layer;
in which the cholesteric fluid, pigment particles, and reflective layer are tuned to modulate a color of light; a first display cell being tuned to modulate a first color of light and a second display cell being tuned to modulate a second color of light.

15. The display of claim 14, in which the display reflects the first color of light when the pigment particles with the first display cell are drawn to the second wall of the first display cell, the cholesteric liquid crystal fluid in the first display cell reflecting a first polarization of the first color of light and the reflective layer reflecting a second polarization of the first color of light.
